(19) United States
(12) Patent Application Publication
(10) Pub. No.: US 2026/0061870 A1
(43) Pub. Date: Mar. 5, 2026

(54) CHARGING SYSTEM COMPRISING INDUCTION CHARGING DEVICES

(71) Applicant: MAHLE International GmbH, Stuttgart (DE)

(72) Inventor: Mike Boettigheimer, Kornwestheim (DE)

(21) Appl. No.: 19/104,207

(22) PCT Filed: Aug. 11, 2023
(86) PCT No.: PCT/EP2023/072338

§ 371 Date: Feb. 14, 2025

(30) Foreign Application Priority Data
Aug. 16, 2022 (DE) 102022120700.5
Sep. 28, 2022 (DE) 102022210295.9

(51) Int. Cl. B60L 53/36; B60L 53/126; B60L 53/30; B60L 53/38; B60L 53/66

(52) U.S. Cl. CPC B60L 53/36; B60L 53/126; B60L 53/305; B60L 53/38; B60L 53/66

(57) ABSTRACT

A stationary induction charging device configured to inductively interact with a mobile induction charging device of a motor vehicle during a charging operation for wireless power transmission includes a positioning device configured to generate a positioning signal for positioning the mobile induction charging device to the stationary induction charging device. The stationary induction charging device further includes an activation interface configured to at least partially activate or deactivate the positioning device upon receiving a corresponding signal from a triggering device.

### CROSS-REFERENCE TO RELATED APPLICATIONS

This application claims priority to International Patent Application No. PCT/EP2023/072338, filed on Aug. 11, 2023, German Patent Application No. DE102022120700.5, filed on Aug. 16, 2022, and German Patent Application No. DE102022210295.9, filed on Sep. 28, 2022, the contents of all of which are hereby incorporated by reference in their entirety.

### TECHNICAL FIELD

The present invention relates to a charging system with stationary induction charging devices for wireless power transmission with motor vehicles. The invention also relates to a parking system with a parking lot and a charging system of this kind.

### BACKGROUND

Wireless power transmission with a motor vehicle can be done inductively. For this purpose, a mobile induction charging device of the motor vehicle works together with a stationary induction charging device. The respective induction charging device has an energy coil, wherein one of the energy coils acts as the primary coil and the other energy coil acts as the secondary coil for the transmission of energy. To enable such an energy transfer and to increase the efficiency of the energy transfer, the energy coils and thus the mobile induction charging device are to be positioned accordingly in relation to the stationary induction charging device.

A charging system can have several such stationary induction charging devices, so that the respective stationary induction charging device can wirelessly transfer energy to a mobile induction charging device of a motor vehicle.

### SUMMARY

The present invention is concerned with the task of specifying improved or at least different embodiments for a charging system of the type described above and for a parking system comprising such a charging system, which in particular eliminate disadvantages from the prior art. In particular, the present invention is concerned with the task of providing improved or at least alternative embodiments for the charging system as well as for the parking system, which are characterized by improved efficiency combined with improved operation and increased comfort. According to the invention, this task is solved by the subject matter of the independent claims. Advantageous embodiments are the scope of the dependent claims.

The present invention is therefore based on the general idea of in a charging system with stationary induction charging devices for wireless power transmission with a mobile induction charging device of a motor vehicle, to equip the respective stationary induction charging device with a positioning device which, in the active state, generates at least one positioning signal for positioning the mobile induction charging device relative to the stationary induction charging device. This way, the mobile induction charging device and thus the associated motor vehicle can be positioned in the desired way and with increased precision in relation to the respective stationary induction charging device. This enables a sufficiently high coupling between the stationary induction charging device and the mobile induction charging device in a simple manner, so that energy is transferred, and also leads to improved energy transfer between the respective stationary induction charging device and the mobile induction charging device positioned in relation to it. This results in increased efficiency of the charging system. At the same time, the present invention is based on the general idea of dividing the stationary induction charging devices into groups and at least partially deactivating the positioning devices of the respective group in each case and only activating them when a motor vehicle approaches the group. This has the consequence that the stationary induction charging devices of the respective group are only then fully operated, in particular only then generate the positioning signal completely, when a power transmission with the mobile induction charging device of a motor vehicle seems probable or the possibility exists at all. This reduces the energy consumption of the charging system. This in turn leads to increased efficiency of the charging system. At the same time, activating the positioning devices of the respective group offers a motor vehicle a selection of possible available stationary induction charging devices, to which the motor vehicle can be positioned by means of the associated positioning device. This results in improved operation and increased comfort.

In line with the inventive concept, the charging system comprises several stationary induction charging devices that are spaced apart from one another. The respective stationary induction charging device interacts inductively with a mobile induction charging device of a motor vehicle in a charging operation for wireless power transmission. The stationary induction charging devices are divided into at least two groups, with each group comprising at least two stationary induction charging devices. The respective stationary induction charging device has a positioning device which, in a positioning operation for positioning a mobile induction charging device of a motor vehicle to the stationary induction charging device, generates a positioning signal. The respective induction charging device has an interface for activating and deactivating the positioning device, which will also be referred to below as the activation interface. The respective group also has a device that detects when a motor vehicle approaches the group, which will be referred to below as a triggering device. The respective triggering device is designed in such a way that it recognizes the approach of a motor vehicle to the associated group. The respective triggering device is connected to the activation interfaces of the stationary induction charging devices of the corresponding group in a way that allows them to communicate. In this case, the respective triggering device activates at least some of the positioning devices, at least of the unoccupied stationary induction charging devices of the associated group, by means of the activation interfaces, when it detects that a motor vehicle is approaching the associated group. The respective triggering device is designed accordingly.

The positioning devices are, as explained, at least partially deactivated and are only activated when a motor vehicle of the associated group approaches. This means that each of the positioning devices is at least partially deactivated and is only activated when a motor vehicle of the corresponding group approaches.

In the present case, “each individual” is to be understood by “respective”. “The respective positioning system of a group”thus means “each individual positioning system of the group”.

The partial activation of the respective positioning device means that the rest of the positioning device, i.e., in the deactivated state, is correspondingly at least partially deactivated. The partial activation of the positioning devices of a group, depending on the approach of a motor vehicle to this group, means that the positioning devices of the other groups are in the deactivated state, in particular if no motor vehicle approaches these other groups.

The respective positioning device can be fully activated by means of the triggering device. This is particularly the case if the positioning device is completely deactivated when deactivated, i.e., switched off.

Partial activation of the positioning system is useful when the positioning system is only partially deactivated in the deactivated state. In the deactivated state, the positioning device can, for example, be in a stand-by state in which the positioning device at least partially generates the positioning signal. In particular, it is conceivable that the positioning device generates a positioning signal for long-proximity positioning or rough positioning of a motor vehicle in standby mode.

In the following, “activating” and “activation” are to be understood as meaning a preferably complete activation of the positioning device so that the positioning device completely generates the positioning signal.

In the following, “deactivating” and “deactivation” refers to at least a partial deactivation of the positioning device so that the positioning device is either completely switched off or in standby mode.

The design according to the invention is advantageous, because, as long as no motor vehicle approaches the charging system, all of the positioning devices can be in a relatively energy-efficient deactivated state and, as soon as a motor vehicle of a group approaches the charging system, only the positioning devices of this group are activated and all of the other positioning devices can remain in a relatively energy-efficient deactivated state.

The respective stationary induction charging device is designed to wirelessly transfer energy with a single motor vehicle, in particular with a single mobile induction charging device. This means in particular that the respective stationary induction charging device advantageously forms a charging point of the charging system.

In this case, approaching a group is understood to mean, in particular, that the distance between a motor vehicle and the group is less than a specified value.

An unoccupied stationary induction charging device is, in particular, a stationary induction charging device that is not in the process of charging and/or positioning. This means that those stationary induction charging devices are unoccupied that are available for wireless power transmission to a motor vehicle.

Preferred are embodiments in which at least one of the triggering devices, preferably the respective triggering device, when recognizing the approach of a motor vehicle, merely activates the positioning devices of the unoccupied stationary induction charging devices. This further reduces the energy consumption of the charging system and thus further increases efficiency. Furthermore, this way there is less overlap of the positioning fields and the vehicle is only offered the stationary induction charging devices that are actually available. This leads to improved operations.

The charging system is used to advantage in a parking system that also includes a parking space. The parking lot includes several parking areas, with at least some of the parking areas being equipped with an associated stationary induction charging device of the charging system. This means that the respective stationary induction charging device is located at an associated parking area. This results in the parking areas being grouped accordingly.

The respective parking area is favorably designed for a single motor vehicle.

At least one of the stationary induction charging devices can be located in the corresponding parking area.

At least one of the stationary induction charging devices can be at least partially recessed into the associated parking area. In particular, at least one of the stationary induction charging devices can be completely recessed in the associated parking area.

The induction charging device has a coil for energy transmission, which will be referred to below as an energy coil. This means that the respective stationary charging device and mobile induction charging device have an energy coil. For wireless power transfer, the energy coil of the stationary induction charging device serves as the primary coil and the energy coil of the mobile induction charging device positioned to the stationary induction charging device serves as the secondary coil, or vice versa. This means that energy transmission in this case also includes bidirectional wireless energy transmission.

The mobile induction charging device is positioned in relation to the stationary induction charging device in such a way that the energy coils are positioned in relation to each other in order to achieve an optimal inductive coupling between the energy coils.

To position the mobile induction charging device, the associated motor vehicle receives the positioning signal, wherein a navigation instruction is advantageously generated and output on the basis of the positioning signal. For receiving the positioning signal, the motor vehicle, in particular the mobile induction charging device, can have at least one corresponding receiver, for example at least one receiving coil.

It is useful to deactivate a positioning device when a mobile induction charging device is positioned in relation to the associated stationary induction charging device, especially when the associated stationary device is in the process of charging.

Charging preferably begins when the mobile induction charging device is positioned in relation to the stationary induction charging device. This means in particular that charging begins after positioning. This reduces energy consumption and makes operation more robust. The respective navigation instruction can be provided to a driver who can drive the motor vehicle in accordance with the navigation instruction, in particular steer it, in order to achieve the positioning of the induction charging devices in relation to one another. Alternatively or additionally, the respective navigation instruction can be issued to a driver assistance system for at least partially autonomous driving of the motor vehicle, so that the driver assistance system drives the motor vehicle at least partially autonomously by means of the navigation instruction for positioning the induction charging devices in relation to one another.

The start of the positioning, i.e., the so-called “pairing” between the motor vehicle and the stationary induction charging device, is best done when driving up to the corresponding stationary induction charging device, in particular when driving up to the associated parking area. Activating the positioning devices of the respective group allows the respective motor vehicle to select from the available, i.e., unoccupied, stationary induction charging devices, in particular parking areas, of the respective group.

The positioning signal can be of any type.

In particular, the positioning signal may comprise at least one field. This means that the positioning device can create at least one field.

Advantageously, at least one of the at least one field, preferably the respective field, is a magnetic field. This results in a simplified and robust reception of the positioning signal by the vehicle, especially in comparison to electromagnetic fields, so that the positioning is reliable and robust.

To generate the respective magnetic field, the positioning device can comprise at least one coil, which will also be referred to below as a transmission coil. The respective transmission coil is advantageously different from the energy coil of the stationary induction charging device. At least one of the positioning devices, advantageously the respective positioning device, preferably generates at least two fields that are offset with respect to one another, at least two magnetic fields that are offset with respect to one another, whose relationship is used for positioning. This enables simplified positioning, especially without prior calibration.

Furthermore, the respective triggering device is preferably designed that it detects an absence state of the associated group in which no motor vehicle is located in the group or all the motor vehicles located in the group are in the charging operation and no motor vehicle of the group is approaching, and deactivates the positioning devices of the associated group by means of the activation interfaces when the absence state is detected.

Preference is given to alternatively or additionally deactivating the positioning devices of the associated group when a motor vehicle that has previously approached the group begins to position itself within the group with one of the associated stationary induction charging devices and/or transfers energy, that is to say, in particular, when one of the stationary induction charging devices of the group is in charging operation with the mobile induction charging device of the motor vehicle. The respective triggering device can be designed as required to detect the approach of a motor vehicle.

It is conceivable that at least one of the triggering devices for detecting the approach of a motor vehicle to the associated group has and/or monitors a motion detector and/or an induction loop in the ground or in a roadway and/or an optical barrier and/or an opening device for opening a gate or a barrier.

Embodiments in which at least one of the triggering devices has a wireless communication interface that covers a zone comprising the associated group with a wireless network and communicates with motor vehicles by means of the network are considered preferred. In this case, an approach of a motor vehicle is detected when the motor vehicle communicates with the wireless communication interface. The approach of a motor vehicle can therefore be detected when the vehicle enters the zone covered by the network. This ensures simple and reliable detection of the approach of a motor vehicle without the need for any structural measures. In particular, it is not necessary to carry out any construction work on the ground and/or the roadway for this purpose. The triggering device also uses the wireless network to detect whether a motor vehicle is in the associated group or moving away from the group. Such detection, in particular the detection of the absence state, preferably occurs when no motor vehicle is communicating with the wireless communication interface by means of the wireless network.

The wireless communication interface generates the wireless network and covers the zone with the network. In particular, the zone corresponds to the region covered by the network.

The respective motor vehicle has a corresponding on-board communication interface for communicating with the network, which will also be referred to below as a wireless interface. In particular, the motor vehicle is capable of receiving and emitting communication signals by means of the on-board wireless interface.

Preference is given to embodiments in which at least two of the triggering devices, preferably the respective triggering device, has such a wireless communication interface. Accordingly, the charging system comprises at least two such zones, with each zone comprising at least one such group, preferably a single such group.

Preferred are embodiments in which at least one of the triggering devices, preferably the respective triggering device, uses only the wireless communication interface and thus the network generated by means of the wireless communication interface to detect the approach of a motor vehicle.

The respective wireless network can be of any type.

In preferred embodiments, at least one of the at least one network is preferably the respective network and is a network according to the IEEE 802.11 standard, i.e., preferably a WLAN. In particular, the wireless communication interface is a WLAN base station, for example a WLAN access point and/or a WLAN router. This means that, in addition to a large covered region and consequently a large zone for using already existing/released frequencies for the wireless communication interface and thus for detecting the approach of a motor vehicle. As a result, the charging system can operate with fewer wireless interfaces and/or does not require a special frequency to detect proximity. Consequently, the charging system is cost-effective, simple, and reliable at the same time. Furthermore, this approach avoids or at least reduces interactions between the wireless network and the fields generated by the energy coils and/or transmission coils. This reduces the susceptibility to faults and increases the reliability of the charging system. Furthermore, communication interfaces according to the IEEE 802.11 standard, standard products, for example in the form of corresponding chips, are available at a low cost, so that the charging system is implemented in a compact and cost-effective way.

If at least two triggering devices each have such a wireless communication interface, the signal of the wireless network of the associated triggering device is stronger in the respective group than the signal of the wireless network of the respective other triggering device. The wireless communication interfaces are arranged and/or designed accordingly. In other words, at least some of the stationary induction charging devices in the respective group, preferably all stationary induction charging devices in the respective group, are assigned to the triggering device with the strongest wireless signal locally. This leads to increased reliability of the charging system, in particular the activation and deactivation of the stationary induction charging devices.

Embodiments in which at least one of the at least one wireless communication interfaces, preferably the respective wireless communication interface, is arranged in the center of the associated group, are considered advantageous. This ensures that the associated group is reliably covered by the wireless network, so that the approach of vehicles from different directions can be reliably and easily detected. Another advantage of this is that the associated group is arranged in the center of the associated zone. This in turn means that the approach of vehicles from different directions, and in particular from all directions, is detected in a consistent, reliable, and simple manner.

At least one of the at least one wireless communication interfaces, in particular the WLAN base station, for example the WLAN access point and/or the WLAN router, can be separate from the associated stationary induction charging devices, in particular also at a distance from them. In particular, this means that the wireless communication interface is a separate component in the associated group.

It is conceivable that at least one of the at least one wireless communication interfaces, in particular the WLAN base station, for example the WLAN access point and/or the WLAN router, is provided in one of the associated stationary induction charging devices. Since stationary induction charging devices usually already have such wireless communication interfaces, in particular according to the IEEE 802.11 standard, for example to communicate with the mobile induction charging device, no further components are required to create the network. In particular, the wireless communication interface is provided in one of the stationary induction charging devices arranged in the center of the associated group. Thus, the wireless communication interface is also an integral component of the associated stationary induction charging device. This simplifies the installation of the charging system, especially in the associated parking lot. In addition, the stationary induction charging devices of a group can be arranged one after the other in a modular fashion, so that each group corresponds to a “module”.

The respective activation interface can be designed as desired.

It is conceivable that at least one of the at least one activation interface, in particular the respective activation interface, is a wireless interface. This reduces the installation effort and the number of components of the local system.

Preferred embodiments are those in which at least one of the at least one activation interfaces designed as a wireless interface is communicatively connected to the triggering device by means of the wireless network. Thus, the wireless network is used to detect the approach of a motor vehicle and to activate and/or deactivate the corresponding positioning devices. In principle, the respective groups can transition into one another without interruption. This makes it possible, in particular, to continuously activate and deactivate the mobile induction charging devices of neighboring groups.

It is advantageous to provide a free region, for example a parking space, between at least two neighboring groups, which is free of stationary induction charging devices. This results in a clear separation of the groups, which in turn results in a clear separation of the activation and deactivation of the positioning devices belonging to the respective groups. This results in improved operation and reduced energy consumption of the charging system. The latter leads to increased efficiency.

In principle, at least one stationary induction charging device in the transition region between two groups can be assigned to both groups, with each group comprising at least one other stationary induction charging device that is not assigned to the second group. The affiliation of at least one stationary induction charging device to two groups enables, in particular, continuous activation and deactivation of the positioning devices of the stationary induction charging devices of the two groups.

Preferably, the respective stationary induction charging device is assigned to a single group. This results in a clear separation of the groups, which in turn results in a correspondingly clear separation of the activation and deactivation of the positioning devices belonging to the groups. This results in improved operation and reduced energy consumption of the charging system, thus also achieving increased efficiency.

It is conceivable that at least one of the stationary induction charging devices has a bus system with the activation interface.

Alternatively, or in addition, at least one of the stationary induction charging devices can have a pin system with the activation interface.

The activation interface is advantageously arranged in the electronics of a particular stationary induction charging device. This is how the communicating connection with the associated triggering device can be established. In particular, the signals can be received via this to indicate whether the positioning device should be activated and/or deactivated.

The electronics belonging to a stationary induction charging device are not necessarily located in the device itself, but can also be located remotely, for example in a so-called “wallbox”. Communication with the associated positioning device can therefore take place via the remotely located electronics, in particular via the wallbox.

It is understood that in addition to the charging system, a parking system with a parking space and the charging system is also included in the scope of this invention.

Further important features and advantages of the invention are apparent from the dependent claims, from the drawings and from the associated description of the figures with reference to the drawings.

It is understood that the above-mentioned features and those yet to be explained below can be used not only in the combination indicated in each case, but also in other combinations or on their own, without deviating from the scope of the present invention.

Preferred exemplary embodiments of the invention are shown in the drawings by way of example and will be explained in more detail in the following description, wherein identical reference signs refer to identical or similar or functionally identical elements.

### BRIEF DESCRIPTION OF THE DRAWINGS

It shows, schematically in each case:

FIG. 1 shows a highly simplified plan view of a charging system with stationary induction charging devices in a parking lot system;

FIG. 2 shows a highly simplified, circuit-like representation of a stationary induction charging device in a charging operation;

FIG. 3 shows a simplified cross-section of the stationary induction charging device; and

FIG. 4 shows a greatly simplified, circuit-like representation of a group of the charging system.

### DETAILED DESCRIPTION

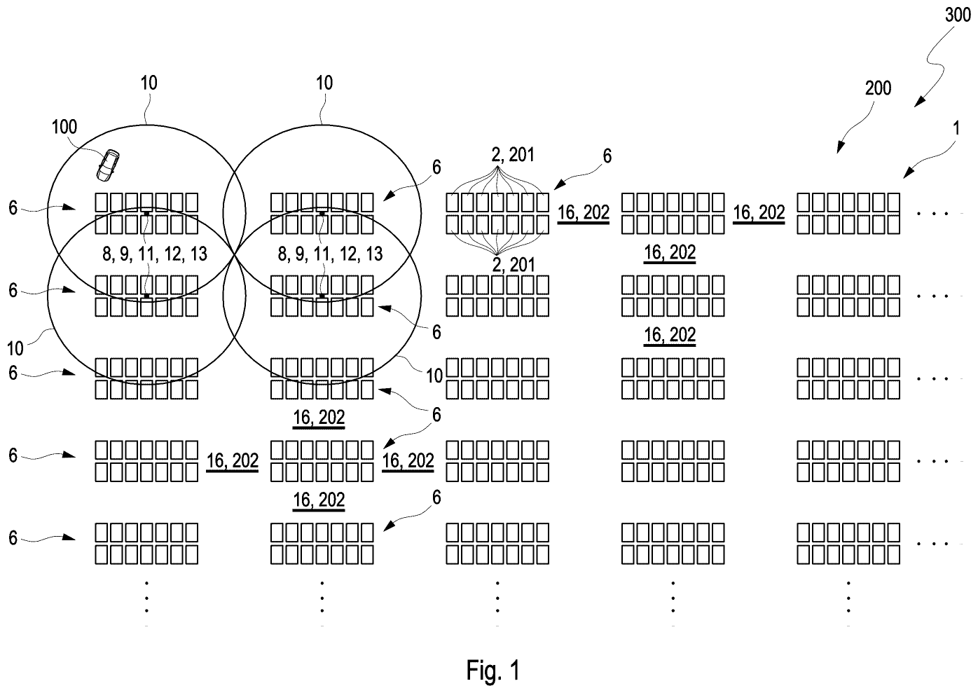

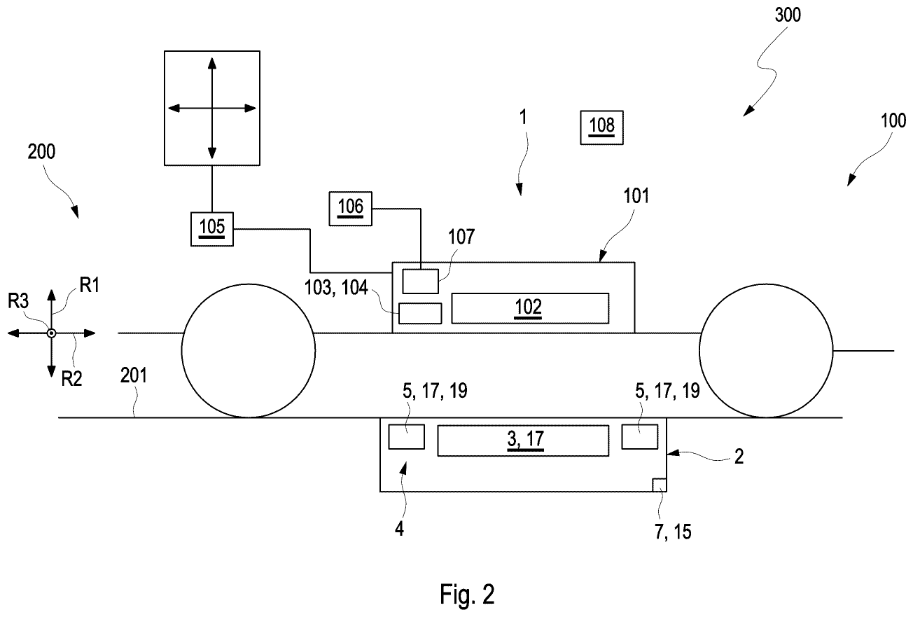

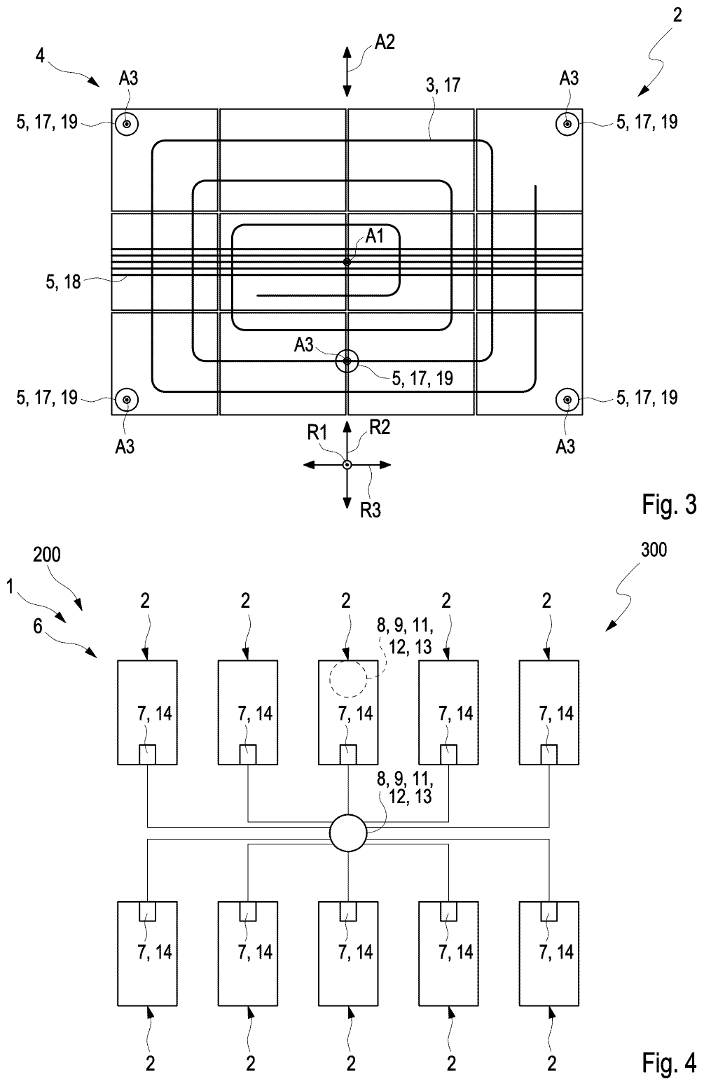

A charging system 1, as exemplarily shown in FIGS. 1, 2, and 4, is used for wireless power transmission by means of induction. For this purpose, the charging system 1 has several stationary induction charging devices 2 that are spaced apart from one another. As can be seen from FIG. 2, the respective stationary induction charging device 2 is used in a charging operation for wireless power transmission with a motor vehicle 100. When charging, the respective stationary induction charging device 2 is thus a charging point of the charging system 1. For this purpose, the motor vehicle 100 has a mobile induction charging device 101. When charging, the stationary induction charging device 2 and the mobile induction charging device 101 for wireless power transmission work together inductively. For wireless energy transmission, the respective stationary induction charging device 2 has a coil 3, which will also be referred to below as stationary energy coils 3. For this purpose, the mobile induction charging device 101 has a coil 102 that inductively interacts with the stationary energy coil 3, which will also be referred to below as the mobile energy coil 102. As can be seen in FIG. 2, the energy coils 3, 102 for wireless power transmission are to be positioned in relation to each other in such a way that they couple inductively. For increased coupling between the energy coils 3, 102 and thus for increased efficiency, the energy coils 3, 102 are to be optimally positioned in relation to each other so that optimal coupling is achieved. To make it work and to increase its efficiency, the mobile induction charging device 101 and thus the motor vehicle 100 must therefore be positioned accordingly relative to the stationary induction charging device 2. The induction charging devices 2, 101 are spaced apart in a vertical direction R1. In addition, in order to enable charging and to achieve high efficiencies during charging, the energy coils 3, 102 are positioned relative to one another transversely to the vertical direction R1, that is to say in a longitudinal direction R2 running transversely to the vertical direction R1, and in a transverse direction R3 running transversely to the vertical direction R1 and the longitudinal direction R2. For positioning, the respective stationary induction charging device 2, as shown only in FIGS. 2 and 3, has a positioning device 4 which, in a positioning operation for positioning the mobile induction charging device 102 and thus the motor vehicle 100 relative to the stationary induction charging device 2, generates a positioning signal. In the exemplary embodiments shown, the respective positioning device 4 generates a magnetic positioning signal with at least one magnetic field. For this purpose, the positioning device 4 has at least one coil 5, which will also be referred to below as the transmission coil 5. In addition, the motor vehicle 100, in the illustrated exemplary embodiments, the mobile induction charging device 101, has a receiver 103 for receiving the positioning signal. In the exemplary embodiment shown in FIG. 2, the receiver 103 is a coil 104, which will also be referred to below as the receiving coil 104. In this process, a navigation instruction is generated by means of the received positioning signal, which is indicated in FIG. 2 by crossed arrows. The navigation instructions are used to drive, in particular to steer, the motor vehicle 100 to position the induction charging devices 2, 101 in relation to each other. In this case, the evaluation of the positioning signal and the generation and output of the navigation instruction can be carried out by means of a control device 105 of the motor vehicle 100. In particular, energy can be transferred to the mobile induction charging device 101 in order to charge a battery 106 of the motor vehicle 100. For this purpose, a rectifier 107 can be provided between the mobile energy coil 102 and the battery 106, which converts the voltage induced in the mobile energy coil 102 into a rectified voltage. Power can also be transferred from the mobile induction charging device 101 to the stationary induction charging device 2. As can be seen in FIG. 1, the stationary induction charging devices 2 are divided into at least two groups 6, with each group 6 comprising at least two stationary induction charging devices 2. FIG. 4 shows one of the groups 6. In FIG. 1, the respective group includes 6 stationary induction charging devices 2, purely by way of example. In FIG. 4, the group shown comprises 6 stationary induction charging devices 2 as examples.

As can also be seen in particular from FIG. 4, the respective stationary induction charging device has an interface 7 by means of which the positioning device 4 can be activated and deactivated. Interface 7 is also referred to below as activation interface 7. As can be seen from FIGS. 1 and 4, the charging system 1 for each group 6 has an associated device 8 which is designed to detect when a motor vehicle 100 approaches the associated group 6. The device 8 is also referred to below as triggering device 8. The respective triggering device 8 is, as indicated in FIG. 4, communicatively connected to the activation interfaces 7 of the stationary induction charging devices 2 of the associated group 6. The triggering device 8 activates the positioning mechanisms 4 of at least the unoccupied stationary induction charging devices 2, preferably only the unoccupied stationary induction charging devices 2 of the associated group 6, by means of the activation interfaces 7, when it detects the approach of a motor vehicle 100 to the associated group 6. The triggering device 8 is designed accordingly. Thus, the positioning devices 4 are not permanently active. As a result, the energy consumption of charging system 1 is reduced and thus the efficiency of charging system 1 is increased. At the same time, the positioning device 4 is used to easily and reliably position the induction charging devices 2, 102 in relation to one another, wherein the respective unoccupied stationary induction charging device 2 of group 6 is offered to the respective motor vehicle 100 and is available. This means that the motor vehicle 100 can approach each of the unoccupied stationary induction charging devices 2 for positioning with the stationary induction charging device 2, the positioning device 4 enabling the motor vehicle 100 to be positioned in a simplified and precise manner.

In FIG. 1, only four of the groups 6 are shown for the sake of clarity.

The respective triggering device 8 is also designed in such a way that it detects an absence of the associated group 6, in which there is no motor vehicle 100 in the group 6 or all the motor vehicles 100 in the group are in the charging operation and no motor vehicle 100 of the group 6 is approaching, wherein the triggering device 8 deactivates the positioning means 4 of the associated group 6 by means of the activation interfaces 7 when the absence condition is detected. The respective triggering device 8 is preferably also designed in such a way that it deactivates the positioning devices 4 of the stationary induction charging devices 2 of the associated group 6 when the respective motor vehicle 100 located within the group is in the charging operation.

The charging system 1 can be used in a parking lot 200, as indicated in FIG. 1, and thus forms a parking lot system 300 with the parking lot 200. The parking lot 200 includes several parking areas 201, wherein the respective parking area 201 is used for parking one motor vehicle 100. At least some of the parking spaces 201 are provided with an associated stationary induction charging device 2 of the charging system 1. In the example shown in FIG. 1, parking space 201 is equipped with a stationary induction charging device 2 of the charging system 1. This results in an analogous grouping of the parking spaces 201. As can be seen from FIG. 2, in the exemplary embodiment shown, the stationary induction charging device 2 is recessed in the associated parking area 201.

As can be seen from FIG. 1, in the illustrated exemplary embodiments, a region 16 free of stationary induction charging devices 2 is provided in each case between the neighboring groups 6, which region is formed by a roadway 202 of the parking lot 200. As can also be seen from FIG. 1, in the exemplary embodiment shown, the respective stationary induction charging device 2 is assigned to only one of the groups 6. This means that groups 6 do not share any stationary induction charging devices 2.

In the exemplary embodiments shown, the respective triggering device 8 has a wireless interface 9 that covers a zone 10 comprising the associated group 6 with a wireless network. In the following, interface 9 is also referred to as communication interface 9. FIG. 1 shows only the four triggering devices 8 and the associated zone 10. As can be seen in FIG. 1, in the exemplary embodiment shown, each group 6 is only arranged in the associated zone 10. In the exemplary embodiments shown, the respective wireless communication interfaces 9 cover the associated zones 10 with a wireless network according to the IEEE 802.11 standard. The wireless communication interface 9 is therefore in particular a WLAN base station 11, or a WLAN access point 12, in particular a WLAN router 13. The respective triggering device 8 communicates with vehicles 100 via the wireless network. For this purpose, the respective motor vehicle 100, as indicated in FIG. 2, can have a corresponding wireless interface 108, which in particular transmits a wireless signal for communication, but preferably also receives. The approach of a motor vehicle 100 is detected when the motor vehicle 100 communicates with the wireless communication interface 9, in particular when it enters the associated zone 10. It is also recognized that a motor vehicle 100 is moving away from the associated group 6 when communication with the motor vehicle 100 is no longer possible, i.e., that the motor vehicle 100 is leaving the associated zone 10.

As indicated in FIG. 1, in the illustrated exemplary embodiments, in each respective group 6, the wireless network signal of the associated triggering device 8 is stronger than the wireless network signal of the respective other triggering device 8. This means that the stationary induction charging devices 2 of each group 6 are assigned to the triggering device 8 with the locally strongest wireless signal. As can be seen in FIG. 1, in the exemplary embodiment shown, the respective zone 10 is spaced apart from the other groups 6. This means that in the exemplary embodiment shown, the respective zone 10 does not extend into other groups 6. As indicated in FIGS. 1 and 4, in the exemplary embodiments shown, the respective wireless communication interface 9, in particular the respective triggering device 8, is arranged in the center of the associated group 6. In addition, the respective group 6 is located in the center of the associated zone 10.

As can be seen from FIGS. 1 and 4, in the illustrated exemplary embodiments, the respective wireless communication interface 9 is separate from and spaced apart from the associated stationary induction charging device 2. As indicated by the dashed line in FIG. 4, at least one of the wireless communication interfaces 9 can also be provided in one of the associated stationary induction charging devices 2 of the associated group 6, and thus be a component of this stationary induction charging device 2. As also indicated in FIG. 4, this is one of the centrally arranged stationary induction charging devices 2 of group 6. As indicated in FIG. 4, at least one of the activation interfaces 7, in the illustrated exemplary embodiment the respective activation interface 7, can be a wireless interface 14, so that the activation and so that the communication with the associated triggering device 8 is carried out wirelessly. In the illustrated exemplary embodiment and preferably, the activation interface 7 designed as a wireless interface 14 is connected to the triggering device 7 in a communicating manner by means of the wireless network.

As indicated in FIG. 2 in a highly simplified manner, at least one of the stationary induction charging devices 2 can also have a bus system 15 with the activation interface 7. In the exemplary embodiments shown, the stationary energy coils 3 are each a flat coil 17. As can be seen from FIG. 3, for example, the stationary energy coil 3 is wound around a winding axis A1 running parallel to the vertical direction R1.

As can be seen in FIGS. 2 and 3, the respective positioning device 4 has at least four transmission coils 5, although only two of the transmission coils 5 can be seen in FIG. 2. As can only be seen in FIG. 3, one of the transmission coils 5 generates a magnetic field directed in the longitudinal direction R2. This transmission coil 5 is also referred to below as the long-proximity coil 18. Preferably, the longitudinal direction R2 is the direction of travel of the motor vehicle 100, i.e., the X-direction of the motor vehicle 100. In the exemplary embodiment shown, the long-proximity coil 18 is wound around a winding axis A2 running parallel to the longitudinal direction R1. As can also be seen in particular from FIG. 3, the stationary induction charging device 2 in the shown exemplary embodiments has at least four further transmission coils 5 that are offset with respect to one another, and each generate a magnetic field that is directed in the vertical direction R1. These transmission coils 5 are also referred to below as short-proximity coils 19. In the exemplary embodiment shown in FIG. 3, the positioning device 4 has a total of five such short-proximity coils 19. As can also be seen in particular from FIG. 3, the respective short-proximity coil 19 is formed as a flat coil 17, which is wound around a winding axis A3 running parallel to the vertical direction R1. As can be seen in particular from FIG. 3, the transmission coils 5 are different from the stationary energy coil 3. As can also be seen in FIG. 3, the short-proximity coils 19 are smaller than the stationary energy coil 3. The magnetic field generated by the long-proximity coil 18 is used primarily for long-proximity positioning, especially for distances of more than 0.5 m, in particular between 1.5 m and 0.5 m. The respective short-proximity coil 19 is preferably used for short-proximity positioning, i.e. in particular for distances of less than 1.5 m, especially less than 0.5 m.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, ”in examples,“ ”with examples,“ ”various embodiments,“ ”with embodiments,“ ”in embodiments,“ or ”an embodiment,“ or the like, means that a particular feature, structure, or characteristic described in connection with the example/embodiment is included in at least one embodiment. Thus, appearances of the phrases ”examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

1-15. (canceled)

16. A stationary induction charging device configured to inductively interact with a mobile induction charging device of a motor vehicle during a charging operation for wireless power transmission, the stationary induction charging device comprising:
a positioning device configured to generate a positioning signal for positioning the mobile induction charging device to the stationary induction charging device, and
an activation interface configured to at least partially activate or deactivate the positioning device upon receiving a corresponding signal from a triggering device.

17. The stationary induction charging device according to claim 16, wherein the positioning device is configured to be deactivated when the mobile induction charging device is positioned relative to the stationary induction charging device, when the stationary induction charging device is in a charging mode, and/or when no motor vehicle is approaching.

18. The stationary induction charging device according to claim 16, wherein the positioning device is configured to generate a positioning signal for remote positioning or rough positioning of the motor vehicle when in a at least partially deactivated state or standby state.

19. The stationary induction charging device according to claim 16, wherein the positioning device is configured to be activated when the triggering device detects an approach of the motor vehicle.

20. The stationary induction charging device according to claim 16, wherein the positioning device is configured to generate a field for positioning the mobile induction charging device.

21. The stationary induction charging device according to claim 20, wherein the field is a magnetic field.

22. The stationary induction charging device according to claim 21, wherein the positioning device has at least one transmitting coil for generating the magnetic field.

23. The stationary induction charging device according to claim 20, wherein the field comprises at least two fields that are offset relative to each other.

24. The stationary induction charging device according to claim 16, wherein the stationary induction charging device comprises a bus system with the activation interface.

25. The stationary induction charging device according claim 16, wherein the activation interface comprises a wireless interface configured to be communicatively connected to the triggering device via a wireless network generated by the triggering device.

26. The stationary induction charging device according to claim 25, wherein the activation interface is arranged in electronics of the stationary induction charging device and the communicating connection with the triggering device is realized via the electronics.

27. The stationary induction charging device according claim 16, wherein the stationary induction charging device further comprises a wireless communication interface of the triggering device.

28. The stationary induction charging device according to claim 27, wherein the wireless communication interface is configured to generate a wireless network based on Institute of Electrical and Electronics Engineers (IEEE) 802.11 standard.

29. The stationary induction charging device according to claim 27, wherein an approach of a motor vehicle is detected when the motor vehicle communicates with the wireless communication interface.

30. A mobile induction charging device for a motor vehicle, configured to interact with a stationary induction charging device during a charging operation for wireless power transmission, the mobile induction charging device comprising:
a receiver for receiving a positioning signal from the stationary induction charging device.

31. The mobile induction charging device according to claim 30, wherein the receiver comprises a receiving coil.

32. The mobile induction charging device according to claim 30, further comprising a communication interface for communicating with a communication interface of a triggering device.

33. The mobile induction charging device according to claim 30, further comprising a control device for evaluating the positioning signal and generating and outputting a navigation instruction based on the positioning signal.

34. A triggering device comprising:
a wireless communication interface configured to communicate with an activation interface of a stationary induction charging device, and, via the activation interface, to activate a positioning device of the stationary induction charging device when detecting that a motor vehicle is approaching and/or to deactivate the positioning device of the stationary induction charging device when a mobile induction charging device is positioned relative to the stationary induction charging device, when the stationary induction charging device is in a charging mode, and/or when no motor vehicle is approaching.

35. The triggering device according to claim 34, wherein the wireless communication interface is configured to generate a wireless network based on Institute of Electrical and Electronics Engineers (IEEE) 802.11 standard.

36. The triggering device according to claim 34, wherein the triggering device is configured to monitor a motion detector and/or an induction loop in a floor and/or an optical barrier and/or an opening device for opening a gate or a barrier for detecting the approach of a motor vehicle.

37. The triggering device according to claim 34, wherein the triggering device is configured to communicate with a wireless communication interface of a motor vehicle to detect the approach of the motor vehicle.
